(19) United States
(12) Patent Application Publication
(10) Pub. No.: US 2025/0121816 A1
(43) Pub. Date: Apr. 17, 2025

(54) UNDERSTEER MITIGATION FOR ELECTRIC TRACTOR TRAILER VEHICLE COMBINATION

(71) Applicant: VOLVO TRUCK CORPORATION, Göteborg (SE)

(72) Inventors: Esteban GELSO, Västra Frölunda (SE); Umur ERDINC, Göteborg (SE); Maliheh SADEGHI KATI, Öjersjö (SE); Leo LAINE, Göteborg (SE)

(73) Assignee: VOLVO TRUCK CORPORATION, Göteborg (SE)

(21) Appl. No.: 18/903,300

(22) Filed: Oct. 1, 2024

(30) Foreign Application Priority Data
Oct. 16, 2023 (EP) 23203836.4

(51) Int. Cl. B60W 30/045; B60W 10/08; B60W 10/18

(52) U.S. Cl. CPC B60W 30/045; B60W 10/08; B60W 10/18; B60W 2300/145; B60W 2510/207; B60W 2520/14; B60W 2552/30

(57) ABSTRACT

A computer system has processing circuitry configured to receive a braking request for braking a vehicle including an electrically powered tractor, and a trailer coupled to the tractor by an articulated coupling; provide a first braking command encoding instructions to control braking on at least a front axle of the tractor, and on a rear drive axle of the tractor to provide a combined braking force fulfilling the braking request; receive a first set of vehicle parameters; determine, based on the first set of vehicle parameters, that an understeer tendency of the vehicle during braking is higher than a predefined first understeer tendency threshold; and provide a second braking command encoding instructions to increase a braking force on the rear drive axle of the tractor using regeneration, and decrease a braking force on the front axle of the tractor, so that the combined braking force fulfills the braking request.

### TECHNICAL FIELD

The disclosure relates generally to vehicle motion management. In particular aspects, the disclosure relates to understeer mitigation for an electric tractor trailer combination vehicle. The disclosure can be applied to heavy-duty vehicles, such as trucks, buses, and construction equipment, among other vehicle types. Although the disclosure may be described with respect to a particular vehicle, the disclosure is not restricted to any particular vehicle.

### BACKGROUND

A tractor trailer combination vehicle may start to understeer when entering a sharp turn, especially when there is relatively low friction between the tires and the road surface and the combination vehicle is braked.

A tendency of a tractor trailer combination vehicle to understeer can be mitigated by controlling the braking forces applied by individual wheels, so that the tractor brakes the inside rear wheel, and the trailer brakes an outside wheel.

For an electric vehicle in general, regenerative braking is crucial for the energy efficiency of the vehicle. In an electric tractor trailer combination vehicle, controlling the amount of braking of individual wheels in order to mitigate understeering may result in sub-optimal use of regenerative braking, and thus lower energy efficiency.

It would be desirable to be able to control an electric tractor trailer combination vehicle in such a way that understeering can be mitigated without sacrificing the energy efficiency of the combination vehicle, while fulfilling a braking request.

### SUMMARY

According to a first aspect of the disclosure, there is provided a computer system comprising processing circuitry configured to: receive a braking request for braking a vehicle including an electrically powered tractor with an electric machine coupled to a rear drive axle of the tractor, and a trailer coupled to the tractor by an articulated coupling; provide a first braking command encoding instructions to control braking on at least a front axle of the tractor, and on the rear drive axle of the tractor to provide a combined braking force fulfilling the braking request; receive a first set of vehicle parameters; determine, based on the first set of vehicle parameters, that an understeer tendency of the vehicle during braking is higher than a predefined first understeer tendency threshold; and provide a second braking command encoding instructions to increase a braking force on the rear drive axle of the tractor using regeneration, and decrease a braking force on the front axle of the tractor, so that the combined braking force fulfills the braking request. The first aspect of the disclosure may seek to enable control of an electric tractor trailer combination vehicle in such a way that understeering can be mitigated without sacrificing the energy efficiency of the combination vehicle, while fulfilling a braking request. A technical benefit may include to mitigate understeer of the combination vehicle while at the same time increasing regeneration of electrical energy. The second braking command may be provided in response to the determination that the understeer tendency of the vehicle during braking is higher than the first understeer tendency threshold. The increase/decrease of the braking forces according to the instructions encoded in the second braking command are in relation to the braking forces according to the instructions encoded in the first braking command. Through the instructions encoded in the second braking command, the combined braking force thus continues to fulfill the braking request, while redistributing the braking forces on the different axles in such a way that the understeer tendency is reduced. The set of vehicle parameters may, for example, include at least one of a longitudinal speed of the vehicle, a steering angle for the vehicle, a longitudinal distance between the front axle and the rear drive axle of the tractor, a yaw rate of the tractor, an articulation angle of the vehicle, coupling forces in the articulated coupling, a side slip angle, a mass of the vehicle, a radius of curvature of the current driving path, and a friction coefficient of the road surface, etc. At least on the rear drive axle of the tractor, the braking force may be substantially evenly distributed among the wheels driven by the axle. This may provide for the use of a simpler and more robust electric power train, with a single electric motor for the rear drive axle of the tractor.

Optionally in some examples, including in at least one preferred example, the first braking command may additionally encode instructions to control braking on at least one axle of the trailer; and the second braking command may additionally encode instructions to decrease a braking force on the at least one axle of the trailer. A technical benefit may include that an understeer tendency may be mitigated more efficiently by additionally controlling the braking force on at least one axle of the trailer.

Optionally in some examples, including in at least one preferred example, the processing circuitry may be further configured to: receive a second set of vehicle parameters after having provided the second braking command; determine, based on the second set of vehicle parameters, that the understeer tendency of the vehicle during braking is lower than a predefined second understeer tendency threshold, lower than the first understeer tendency threshold; and provide a third braking command encoding instructions to decrease the braking force on the rear drive axle of the tractor, and increase the braking force on the front axle of the tractor, so that the combined braking force fulfills the braking request. A technical benefit may include that a tendency for excessive oversteering can be prevented, whereby the risk of a potentially dangerous situation, such as jack-knifing, can be reduced.

Optionally in some examples, including in at least one preferred example, the processing circuitry may be further configured to: receive a third set of vehicle parameters after having provided the second braking command; determine, based on the third set of vehicle parameters that that an oversteer tendency of the vehicle during braking is higher than a predefined oversteer tendency threshold; and provide a fourth braking command encoding instructions to reduce the braking force on the rear drive axle of the tractor. A technical benefit may include that a tendency for excessive oversteering can be prevented, whereby the risk of a potentially dangerous situation, such as jack-knifing, can be reduced. In examples where the second braking command additionally encodes instructions to control braking on at least one axle of the trailer, the fourth braking command may additionally encode instructions to increase the braking force on the at least one axle of the trailer.

Optionally in some examples, including in at least one preferred example, the fourth braking command may further encode instructions to increase the braking force on the front axle of the tractor, so that the combined braking force fulfills the braking request. A technical benefit may include that the vehicle may react faster on the fourth braking command when more axles are involved in the braking.

Optionally in some examples, including in at least one preferred example, the fourth braking command may further encode instructions to increase the braking force on the at least one axle of the trailer. A technical benefit may include that the vehicle may react faster on the fourth braking command when more axles are involved in the braking.

Optionally in some examples, including in at least one preferred example, the processing circuitry may be further configured to: receive a propulsion request for propelling a vehicle including an electrically powered tractor with a first electric machine coupled to a rear drive axle of the tractor, a second electric machine coupled to a front drive axle of the tractor, and a trailer coupled to the tractor by an articulated coupling; provide a first propulsion command encoding instructions to control the first electric machine and the second electric machine to provide a combined propulsion force fulfilling the propulsion request; receive a fourth set of vehicle parameters after having provided the first propulsion command; determine, based on the fourth set of vehicle parameters, that an understeer tendency of the vehicle during propulsion is higher than a predefined third understeer tendency threshold; and provide a second propulsion command encoding instructions to control the first electric machine and the second electric machine to increase a propulsion force on the rear drive axle of the tractor, and decrease a propulsion force on the front axle of the tractor, so that the combined propulsion force fulfills the propulsion request. A technical benefit may include to mitigate understeer of the combination vehicle also during propulsion of the vehicle.

Optionally, the computer system according to the first aspect of the disclosure may be comprised in a vehicle.

Optionally in some examples, including in at least one preferred example, the vehicle may include an electrically powered tractor with an electric machine coupled to a rear drive axle of the tractor.

According to a second aspect of the disclosure, there is provided a computer-implemented method of reducing understeer of a vehicle including an electrically powered tractor with an electric machine coupled to a rear drive axle of the tractor, and a trailer coupled to the tractor by an articulated coupling, the method comprising: receiving, by a computer system, a braking request for braking the vehicle; providing, by the computer system, a first braking command encoding instructions to control braking on at least a front axle of the tractor, and on the rear drive axle of the tractor to provide a combined braking force fulfilling the braking request; receiving, by the computer system, a first set of vehicle parameters; determining, by the computer system, based on the first set of vehicle parameters, that an understeer tendency of the vehicle during braking is higher than a predefined first understeer tendency threshold; and providing, by the computer system, a second braking command encoding instructions to increase a braking force on the rear drive axle of the tractor using regeneration, and decrease a braking force on the front axle of the tractor, so that the combined braking force fulfills the braking request. The second aspect of the disclosure may seek to enable control of an electric tractor trailer combination vehicle in such a way that understeering can be mitigated without sacrificing the energy efficiency of the combination vehicle, while fulfilling a braking request. A technical benefit may include to mitigate understeer of the combination vehicle while at the same time increasing regeneration of electrical energy. The second braking command may be provided in response to the determination that the understeer tendency of the vehicle during braking is higher than the first understeer tendency threshold. The increase/decrease of the braking forces according to the instructions encoded in the second braking command are in relation to the braking forces according to the instructions encoded in the first braking command. Through the instructions encoded in the second braking command, the combined braking force thus continues to fulfill the braking request, while redistributing the braking forces on the different axles in such a way that the understeer tendency is reduced. The set of vehicle parameters may, for example, include at least one of a longitudinal speed of the vehicle, a steering angle for the vehicle, a longitudinal distance between the front axle and the rear drive axle of the tractor, a yaw rate of the tractor, an articulation angle of the vehicle, coupling forces in the articulated coupling, a side slip angle, a mass of the vehicle, a radius of curvature of the current driving path, and a friction coefficient of the road surface, etc. At least on the rear drive axle of the tractor, the braking force may be substantially evenly distributed among the wheels driven by the axle. This may provide for the use of a simpler and more robust electric power train, with a single electric motor for the rear drive axle of the tractor.

Optionally in some examples, including in at least one preferred example, the first braking command may additionally encode instructions to control braking on at least one axle of the trailer; and the second braking command may additionally encode instructions to decrease a braking force on the at least one axle of the trailer. A technical benefit may include that an understeer tendency may be mitigated more efficiently by additionally controlling the braking force on at least one axle of the trailer.

Optionally in some examples, including in at least one preferred example, the method may further comprise: receiving, by the computer system, a second set of vehicle parameters after having provided the second braking command; determining, by the computer system, based on the second set of vehicle parameters, that the understeer tendency of the vehicle during braking is lower than a predefined second understeer tendency threshold, lower than the first understeer tendency threshold; and providing, by the computer system, a third braking command encoding instructions to decrease the braking force on the rear drive axle of the tractor, and increase the braking force on the front axle of the tractor, so that the combined braking force fulfills the braking request. A technical benefit may include that a tendency for excessive oversteering can be prevented, whereby the risk of a potentially dangerous situation, such as jack-knifing, can be reduced.

Optionally in some examples, including in at least one preferred example, the processing circuitry may be further configured to: receive a third set of vehicle parameters after having provided the second braking command; determine, based on the third set of vehicle parameters that that an oversteer tendency of the vehicle during braking is higher than a predefined oversteer tendency threshold; and provide a fourth braking command encoding instructions to reduce the braking force on the rear drive axle of the tractor. A technical benefit may include that a tendency for excessive oversteering can be prevented, whereby the risk of a potentially dangerous situation, such as jack-knifing, can be reduced. In examples where the second braking command additionally encodes instructions to control braking on at least one axle of the trailer, the fourth braking command may additionally encode instructions to increase the braking force on the at least one axle of the trailer.

Optionally in some examples, including in at least one preferred example, the fourth braking command may further encode instructions to increase the braking force on the front axle of the tractor, so that the combined braking force fulfills the braking request. A technical benefit may include that the vehicle may react faster on the fourth braking command when more axles are involved in the braking.

Optionally in some examples, including in at least one preferred example, the fourth braking command may further encode instructions to increase the braking force on the at least one axle of the trailer. A technical benefit may include that the vehicle may react faster on the fourth braking command when more axles are involved in the braking.

Optionally in some examples, including in at least one preferred example, the method may further include: receiving, by the computer system, a propulsion request for propelling a vehicle including an electrically powered tractor with a first electric machine coupled to a rear drive axle of the tractor, a second electric machine coupled to a front drive axle of the tractor, and a trailer coupled to the tractor by an articulated coupling; providing, by the computer system, a first propulsion command encoding instructions to control the first electric machine and the second electric machine to provide a combined propulsion force fulfilling the propulsion request; receiving, by the computer system, a fourth set of vehicle parameters after having provided the first propulsion command; determining, based on the fourth set of vehicle parameters, that an understeer tendency of the vehicle during propulsion is higher than a predefined third understeer tendency threshold; and providing, by the computer system, a second propulsion command encoding instructions to control the first electric machine and the second electric machine to increase a propulsion force on the rear drive axle of the tractor, and decrease a propulsion force on the front axle of the tractor, so that the combined propulsion force fulfills the propulsion request. A technical benefit may include to mitigate understeer of the combination vehicle also during propulsion of the vehicle.

According to a third aspect of the disclosure, there is provided a computer program product comprising program code for performing, when executed by the processing circuitry, the method of the second aspect of the disclosure.

According to a fourth aspect of the disclosure, there is provided a non-transitory computer-readable storage medium comprising instructions, which when executed by the processing circuitry, cause the processing circuitry to perform the method of the second aspect of the disclosure.

The disclosed aspects, examples (including any preferred examples), and/or accompanying claims may be suitably combined with each other as would be apparent to anyone of ordinary skill in the art. Additional features and advantages are disclosed in the following description, claims, and drawings, and in part will be readily apparent therefrom to those skilled in the art or recognized by practicing the disclosure as described herein.

There are also disclosed herein computer systems, control units, code modules, computer-implemented methods, computer readable media, and computer program products associated with the above discussed technical benefits.

### BRIEF DESCRIPTION OF THE DRAWINGS

Examples are described in more detail below with reference to the appended drawings.

FIG. 1 is an exemplary vehicle according to an example.

FIG. 2 is an exemplary computer system according to an example.

FIG. 3 is an exemplary illustration of an exemplary driving situation.

FIG. 4 is an exemplary method according to an example.

FIG. 5 is an exemplary diagram of the understeer gradient as a function of time.

FIG. 6 is an exemplary illustration of simulated trajectories for a vehicle.

FIG. 7 is an exemplary method according to an example.

FIG. 8 is an exemplary diagram of the understeer gradient as a function of time.

FIG. 9 is an exemplary method according to an example.

FIG. 10 is an exemplary diagram of the understeer gradient as a function of time.

FIG. 11 is a schematic diagram of an exemplary computer system for implementing examples disclosed herein, according to an example.

### DETAILED DESCRIPTION

The detailed description set forth below provides information and examples of the disclosed technology with sufficient detail to enable those skilled in the art to practice the disclosure.

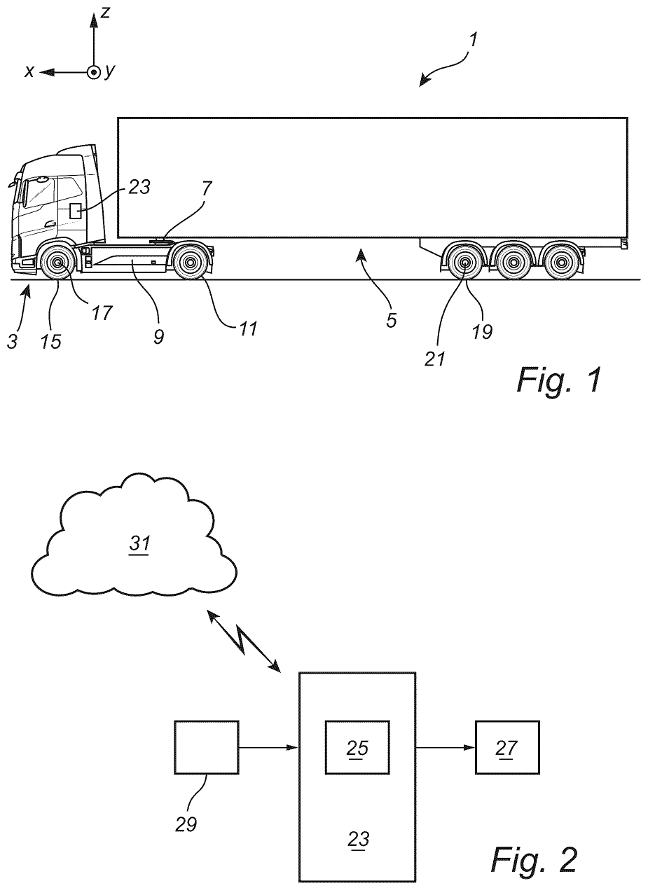

FIG. 1 is an exemplary vehicle combination 1 according to an example. Referring to FIG. 1, the vehicle combination comprises a vehicle in the form of an electric vehicle (EV) tractor 3, and a trailer 5 coupled to the EV tractor 3. In the example in FIG. 1, the trailer 5 is a semitrailer that is coupled to the EV tractor 3 by means of a fifth-wheel coupling 7. The EV tractor 3 has a battery pack 9, driving wheels 11 on a rear drive axle 13 coupled to a first electric machine (not visible in FIG. 1), and front wheels 15 on a front axle 17. According to examples, the front axle 17 may be a front drive axle coupled to a second electric machine (not visible in FIG. 1). Although not visible in FIG. 1, the rear drive axle 13 and the front axle 17 are provided with friction brakes, as is per se known, and it is also possible to control a braking force on the rear drive axle 13 using regeneration, as is per se known. In examples where the front axle 17 is a front drive axle coupled to a second electric machine, it is also possible to control a braking force on the front axle 17 using regeneration, as is per se known. The trailer 5 has at wheels 19 on at least one trailer axle 21. Although not visible in FIG. 1, the at least one trailer axle 21 is provided with friction brakes, as is per se known. Further, the EV tractor 3 comprises a computer system 23. FIG. 1 shows one example of a vehicle combination 1 having a fifth-wheel coupling 7 for articulated coupling between a tractor and a semitrailer type load. It should be noted that the present disclosure relates to other vehicle combinations with other configurations.

FIG. 2 is an exemplary computer system 23 according to an example. The computer system 23 comprises processing circuitry 25, and is coupled to a braking system 27 of the vehicle 1, and to at least one data source. Exemplary data sources are represented in FIG. 2 by a sensing system 29 comprised in the vehicle 1 and a remote data source represented by the cloud 31 in FIG. 2. It should be noted that the computer system 23 need not necessarily be included in the EV tractor 3, but that it may be at least partly included in another part of the vehicle combination 1, or partly or wholly included in a cloud solution, so that processing by the processing circuitry 25 is performed remotely from the vehicle combination 1. If included in the EV tractor 3, the computer system 23 may be provided in the form of a centralized vehicle control unit, or as (a part of) a distributed vehicle control system, which may, for example, include a vehicle motion management control unit and/or a braking system control unit.

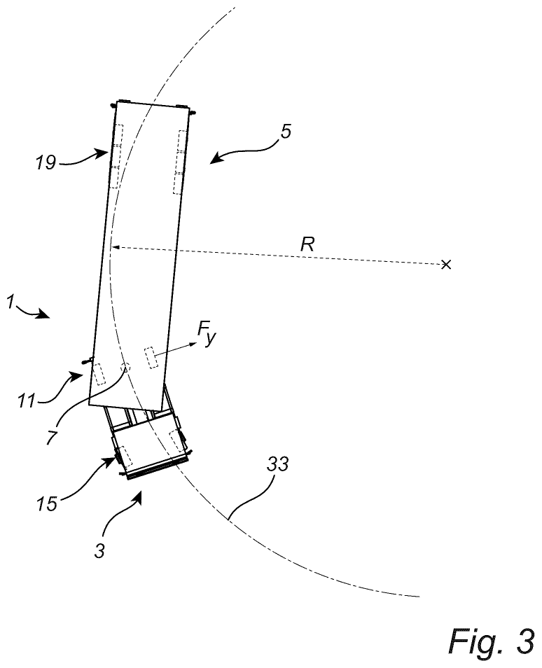

Now consider FIG. 3, which is an exemplary illustration of an exemplary driving situation. In the driving situation in FIG. 3, the present path 33 of the vehicle combination 1 is a non-straight path with a radius of curvature R. In this exemplary vehicle combination 1, the understeering characteristics of the tractor 3 can be represented by the well-known parameter understeering gradient. The understeering gradient Kᵤₛ for the tractor 3 can be determined according to the following formula:

$${K}_{us , tractor} = \frac{{V}_{x , 1} tan δ - {L}_{1} {ω}_{1}}{{V}_{x , 1}^{2} {ω}_{1}} ,$$

where vₓ₁ is the longitudinal speed of the tractor 3, δ is the steering angle of the tractor 3, L₁ is the wheelbase of the tractor 3, and ω₁ is the yaw rate of the tractor 3.

When the vehicle combination 1 is in a sharp curve, and the vehicle combination 1 is braked using a standard braking strategy, where the total braking force is substantially equally distributed among the axles (the rear drive axle 13 of the tractor 3, the front axle 17 of the tractor, and at least one axle 21 of the trailer 5), the vehicle combination 1 can start to understeer heavily, corresponding to a high understeering gradient Kᵤₛ, especially if the friction between the tires of the wheels and the road surface is relatively low, such as in the case of wet asphalt, snow, ice, leaves, oil, etc. According to aspects of the present disclosure, this tendency to understeer is at least partly mitigated, without sacrificing the energy efficiency of the combination vehicle 1, comprising an EV tractor 3, as will be explained in greater detail in the following.

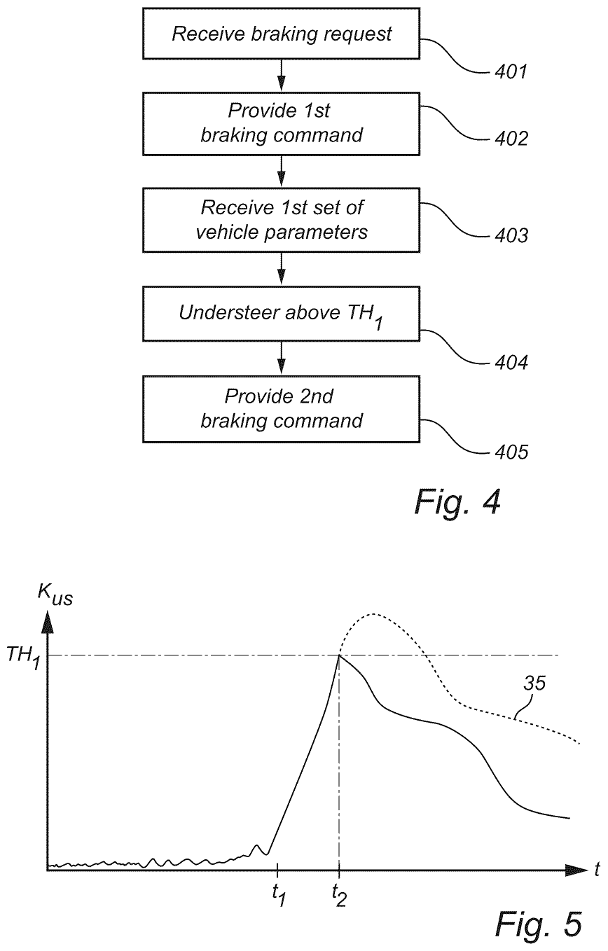

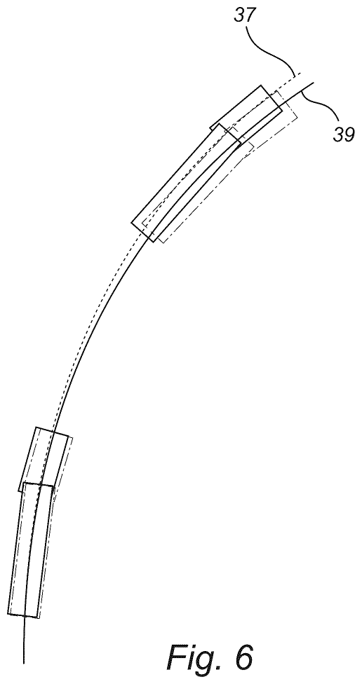

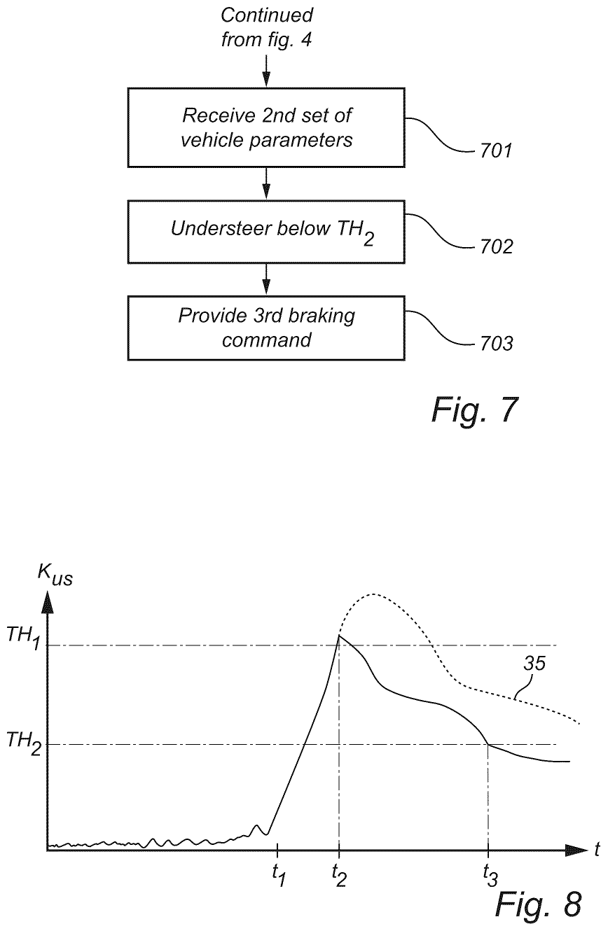

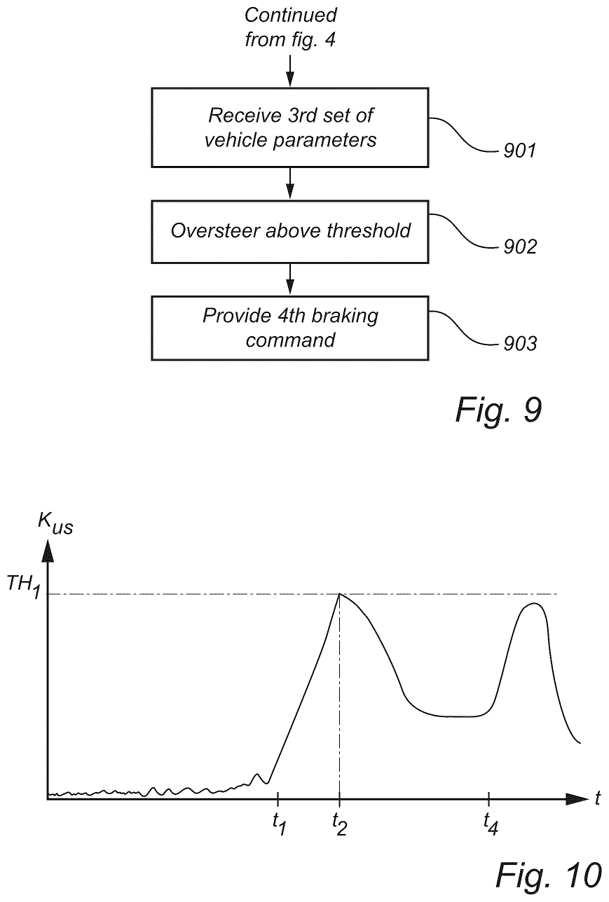

FIG. 4 is an exemplary computer implemented method of reducing understeer of a vehicle including an electrically powered tractor with an electric machine coupled to a rear drive axle of the tractor, and a trailer coupled to the tractor by an articulated coupling. Referring to the flow-chart in FIG. 4, the method comprises receiving 401, by the computer system 23, a braking request for braking the vehicle 1.

In response to receiving the braking request, the computer system 23 provides 402 a first braking command encoding instructions to control braking on at least the front axle 17 of the tractor 3, and on the rear drive axle 13 of the tractor 3 to provide a combined braking force fulfilling the braking request. The first braking command may encode instructions specifying how to control the braking, for example, using a certain distribution among the axles and/or using a certain combination of different vehicle retardation sub-systems, such as friction brakes, and regeneration using at least one electrical machine, etc. For instance, the first braking command may encode instructions to distribute the total combined braking force substantially evenly among the axles (the rear drive axle 13 of the tractor 3, the front axle 17 of the tractor, and at least one axle 21 of the trailer 5).

Referring now briefly to FIG. 5, which is an exemplary diagram of the understeer gradient Kᵤₛ as a function of time t, the first braking command may be provided at a first time t₁ indicated in FIG. 5.

After having provided the first braking command, the computer system 23 receives 403 a first set of vehicle parameters. Such a set of vehicle parameters, including one or more vehicle parameters, may be received from, for example, one or more sensor(s) comprised in a sensing system 29 of the vehicle 1. Alternatively, or in combination, the set of vehicle parameters may be received from a data source that is remote from the vehicle 1. Such a data source 31 may be cloud-based. The set of vehicle parameters may, for example, include at least one of a longitudinal speed of the vehicle 1, a steering angle for the vehicle 1, a longitudinal distance (distance in the x-direction) between the front axle 17 and the rear drive axle 13 of the tractor 3, a yaw rate of the tractor 3, an articulation angle of the vehicle 1, coupling forces in the articulated coupling, a side slip angle, a mass of the vehicle 1, a radius of curvature of the current driving path, and a friction coefficient of the road surface, etc. By yaw rate should be understood angular speed in the yaw plane. Referring briefly to FIG. 1, the yaw plane refers to the xy-plane using well-established geometry conventions for vehicle motion management, where the x-direction refers to the horizontal longitudinal direction for the vehicle, the y-direction refers to the horizontal lateral (sideways) direction for the vehicle, and the z-direction refers to the vertical direction for the vehicle.

The first set of vehicle parameters is then evaluated by the computer system 23, for example by calculating the understeering gradient Kᵤₛ as explained further above with reference to FIG. 3. For instance, current values of the one or more vehicle parameter(s) of the first set of vehicle parameters may be received over time, so that a development over time of the understeering gradient Kᵤₛ can be determined by the processing circuitry 25 of the computer system 23, as is schematically indicated in FIG. 5. As can be seen in FIG. 5, execution of the first braking command, starting at the first time t₁, here results in a sharp increase of the understeering gradient Kᵤₛ.

When it is determined 404, by the computer system 23, based on current values of the one or more vehicle parameter(s) of the first set of vehicle parameters, that an understeer tendency of the vehicle during braking is higher than a predefined first understeer tendency threshold, the computer system provides 405 a second braking command encoding instructions to increase a braking force on the rear drive axle 13 of the tractor 3 using regeneration, and decrease a braking force on the front axle 17 of the tractor 3, so that the combined braking force continues to fulfill the braking request.

Referring again to the example in FIG. 5, the understeering gradient Kᵤₛ becomes higher than a predefined first understeer tendency threshold TH₁ at a second time t₂. At this second time t₂, the second braking command is provided as described above and executed by the braking system 27 of the combination vehicle 1, resulting in lower understeering gradient Kᵤₛ than would have been the case if the first braking command would have continued to be provided and executed, as is represented by the dashed line 35 in FIG. 5.

FIG. 6 is an exemplary illustration of simulated trajectories for a combination vehicle 1. The simulation is based on the following exemplary case:
Road surface: snow (friction coefficient 0.3)
Radius of curvature: 72 m
Accelerating up to 52 km/h
Then brake with two different strategies with substantially the same retardations:
   “Standard” braking strategy, where the total braking force is substantially equally distributed among the axles (the rear drive axle 13 of the tractor 3, the front axle 17 of the tractor, and at least one axle 21 of the trailer 5).
   Understeer mitigation braking strategy where the braking force on the rear drive axle 13 of the tractor 3 has been increased to 0.5 friction utilization, and the braking force on the front axle 17 and the at least one axle 21 of the trailer 5 have been reduced to substantially maintain the same combined braking force.

With the standard braking strategy, the vehicle combination 1 followed the dashed trajectory 37 in FIG. 6, and with the understeer mitigation braking strategy, the vehicle combination 1 followed the solid line trajectory 39 in FIG. 6. Comparing these trajectories, it is clear that the understeer tendency has been reduced by the use of the understeer mitigation braking strategy.

FIG. 7 is an exemplary computer implemented method of reducing understeer of a vehicle including an electrically powered tractor with an electric machine coupled to a rear drive axle of the tractor, and a trailer coupled to the tractor by an articulated coupling. Referring to the flow-chart in FIG. 7, the method is a continuation of the method described above with reference to FIG. 4.

After having provided 405 in FIG. 4 the second braking command, the computer system 23 receives 701 a second set of vehicle parameters. As was explained above for the first set of vehicle parameters, such a set of vehicle parameters, including one or more vehicle parameters, may be received from, for example, one or more sensor(s) comprised in a sensing system 29 of the vehicle 1. Alternatively, or in combination, the second set of vehicle parameters may be received from a data source that is remote from the vehicle 1. Such a data source 31 may be cloud-based. The set of vehicle parameters may, for example, include at least one of a longitudinal speed of the vehicle 1, a steering angle for the vehicle 1, a longitudinal distance (distance in the x-direction) between the front axle 17 and the rear drive axle 13 of the tractor 3, a yaw rate of the tractor 3, an articulation angle of the vehicle 1, coupling forces in the articulated coupling, a side slip angle, a mass of the vehicle 1, a radius of curvature of the current driving path, and a friction coefficient of the road surface, etc. By yaw rate should be understood angular speed in the yaw plane. Referring briefly to FIG. 1, the yaw plane refers to the xy-plane using well-established geometry conventions for vehicle motion management, where the x-direction refers to the horizontal longitudinal direction for the vehicle, the y-direction refers to the horizontal lateral (sideways) direction for the vehicle, and the z-direction refers to the vertical direction for the vehicle.

The second set of vehicle parameters is then evaluated by the computer system 23, for example by calculating the understeering gradient Kᵤₛ as explained further above with reference to FIG. 3. For instance, current values of the one or more vehicle parameter(s) of the second set of vehicle parameters may be received over time, so that a development over time of the understeering gradient Kᵤₛ can be determined by the processing circuitry 25 of the computer system 23, as is schematically indicated in FIG. 8.

When it is determined 702, by the computer system 23, based on current values of the one or more vehicle parameter(s) of the second set of vehicle parameters, that an understeer tendency of the vehicle during braking is lower than a predefined second understeer tendency threshold TH₂, lower than the first understeer tendency threshold TH₁, the computer system provides 703 a third braking command encoding instructions to decrease the braking force on the rear drive axle 13 of the tractor 3, and increase the braking force on the front axle 17 of the tractor 3, so that the combined braking force continues to fulfill the braking request.

Referring again to the example in FIG. 8, the understeering gradient Kᵤₛ becomes lower than the predefined second understeer tendency threshold TH₂ at a third time t₃. At this third time t₃, the third braking command is provided as described above and executed by the braking system 27 of the combination vehicle 1. This results in a redistribution of the braking force towards a more uniform distribution, such as closer to the above-described “standard” braking strategy, while maintaining the understeer tendency of the vehicle 1 at an acceptable level. With the more uniform distribution, the stability of the vehicle 1 may be increased, and tire wear may be more evenly distributed, providing for reduced maintenance of the vehicle 1. The understeering gradient Kᵤₛ is still lower than would have been the case if the first braking command would have continued to be provided and executed, as is represented by the dashed line 35 in FIG. 8, but higher after the third time t₃ than would have been the case if the second braking command would have been maintained.

FIG. 9 is an exemplary computer implemented method of reducing understeer of a vehicle including an electrically powered tractor with an electric machine coupled to a rear drive axle of the tractor, and a trailer coupled to the tractor by an articulated coupling. Referring to the flow-chart in FIG. 9, the method is a continuation of the method described above with reference to FIG. 4.

After having provided 405 in FIG. 4 the second braking command, the computer system 23 receives 901 a third set of vehicle parameters. As was explained above for the first set of vehicle parameters, such a set of vehicle parameters, including one or more vehicle parameters, may be received from, for example, one or more sensor(s) comprised in a sensing system 29 of the vehicle 1. Alternatively, or in combination, the third set of vehicle parameters may be received from a data source that is remote from the vehicle 1. Such a data source 31 may be cloud-based. The set of vehicle parameters may, for example, include at least one of a longitudinal speed of the vehicle 1, a steering angle for the vehicle 1, a longitudinal distance (distance in the x-direction) between the front axle 17 and the rear drive axle 13 of the tractor 3, a yaw rate of the tractor 3, an articulation angle of the vehicle 1, coupling forces in the articulated coupling, a side slip angle, a mass of the vehicle 1, a radius of curvature of the current driving path, and a friction coefficient of the road surface, etc. By yaw rate should be understood angular speed in the yaw plane. Referring briefly to FIG. 1, the yaw plane refers to the xy-plane using well-established geometry conventions for vehicle motion management, where the x-direction refers to the horizontal longitudinal direction for the vehicle, the y-direction refers to the horizontal lateral (sideways) direction for the vehicle, and the z-direction refers to the vertical direction for the vehicle.

The third set of vehicle parameters is then evaluated by the computer system 23. In this case, the third set of vehicle parameters may, for example, include an articulation angle of the vehicle combination 1, that is, an angle in the yaw plane between the longitudinal direction of the tractor 3 and the longitudinal direction of the trailer 5. An increasing articulation angle may be an indication of an increasing oversteer tendency, which may in turn be an indication of an increased risk of so-called jack-knifing.

When it is determined 902, by the computer system 23, based on current values of the one or more vehicle parameter(s) of the third set of vehicle parameters that an oversteer tendency of the vehicle during braking is higher than a predefined oversteer tendency threshold, the computer system provides 903 a fourth braking command encoding instructions to reduce the braking force on the rear drive axle 13 of the tractor 3. In examples where the third set of vehicle parameters includes the articulation angle of the vehicle 1, the oversteer tendency threshold may, for example, by given in the form of a threshold articulation angle, and the fourth braking command may be provided in response to a finding that the articulation angle has become larger than the threshold articulation angle.

Referring to the example in FIG. 10, the oversteer tendency may become higher than the predefined oversteer tendency threshold at a fourth time t₄. At this fourth time t₄, the fourth braking command is provided as described above and executed by the braking system 27 of the combination vehicle 1. This results in a redistribution of the braking force towards a more uniform distribution, such as closer to the above-described “standard” braking strategy, thereby at least temporarily increasing the understeer tendency of the vehicle 1. Hereby, the oversteer tendency of the vehicle 1 can be reduced, which may prevent jack-knifing.

So far, examples of a computer system and computer implemented method have been provided for controlling the braking configuration of the vehicle 1 to achieve a desirable combination of understeering handling and energy efficiency of the vehicle. According to other examples, a propulsion configuration of the vehicle 1 may additionally be controlled with the aim of achieving a desirable understeering handling. However, a detailed description of the control of the propulsion configuration is not provided herein, as the skilled person will be able to suitably control the propulsion based on the examples provided herein for braking, and his/her own knowledge.

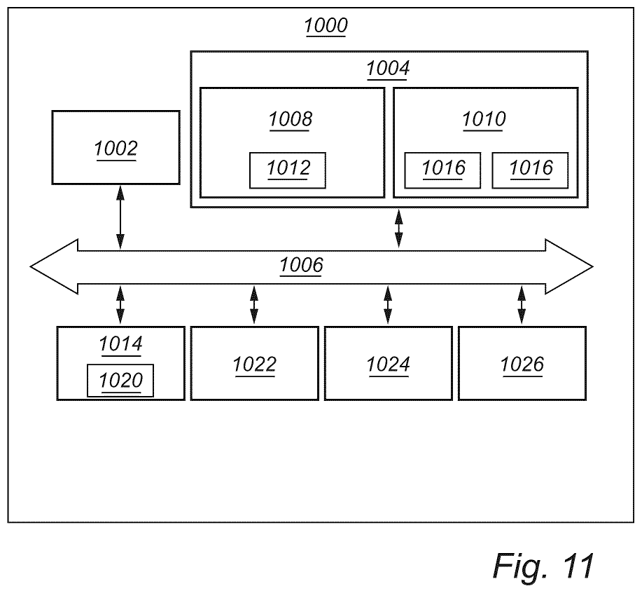

FIG. 11 is a schematic diagram of a computer system 1000 for implementing examples disclosed herein, such as for implementing examples of the control circuitry 23 of the drive train arrangement 5 according to examples. The computer system 1000 is adapted to execute instructions from a computer-readable medium to perform these and/or any of the functions or processing described herein. The computer system 1000 may be connected (e.g., networked) to other machines in a LAN, an intranet, an extranet, or the Internet. While only a single device is illustrated, the computer system 1000 may include any collection of devices that individually or jointly execute a set (or multiple sets) of instructions to perform any one or more of the methodologies discussed herein. Accordingly, any reference in the disclosure and/or claims to a computer system, computing system, computer device, computing device, control system, control unit, electronic control unit (ECU), processor device, processing circuitry, etc., includes reference to one or more such devices to individually or jointly execute a set (or multiple sets) of instructions to perform any one or more of the methodologies discussed herein. For example, control system may include a single control unit or a plurality of control units connected or otherwise communicatively coupled to each other, such that any performed function may be distributed between the control units as desired. Further, such devices may communicate with each other or other devices by various system architectures, such as directly or via a Controller Area Network (CAN) bus, etc.

The computer system 1000 may comprise at least one computing device or electronic device capable of including firmware, hardware, and/or executing software instructions to implement the functionality described herein. The computer system 1000 may include processing circuitry 1002 (e.g., processing circuitry including one or more processor devices or control units), a memory 1004, and a system bus 1006. The computer system 1000 may include at least one computing device having the processing circuitry 1002. The system bus 1006 provides an interface for system components including, but not limited to, the memory 1004 and the processing circuitry 1002. The processing circuitry 1002 may include any number of hardware components for conducting data or indication processing or for executing computer code stored in memory 1004. The processing circuitry 1002 may, for example, include a general-purpose processor, an application specific processor, a Digital indication Processor (DSP), an Application Specific Integrated Circuit (ASIC), a Field Programmable Gate Array (FPGA), a circuit containing processing components, a group of distributed processing components, a group of distributed computers configured for processing, or other programmable logic device, discrete gate or transistor logic, discrete hardware components, or any combination thereof designed to perform the functions described herein. The processing circuitry 1002 may further include computer executable code that controls operation of the programmable device.

The system bus 1006 may be any of several types of bus structures that may further interconnect to a memory bus (with or without a memory controller), a peripheral bus, and/or a local bus using any of a variety of bus architectures. The memory 1004 may be one or more devices for storing data and/or computer code for completing or facilitating methods described herein. The memory 1004 may include database components, object code components, script components, or other types of information structure for supporting the various activities herein. Any distributed or local memory device may be utilized with the systems and methods of this description. The memory 1004 may be communicably connected to the processing circuitry 1002 (e.g., via a circuit or any other wired, wireless, or network connection) and may include computer code for executing one or more processes described herein. The memory 1004 may include non-volatile memory 1008 (e.g., read-only memory (ROM), erasable programmable read-only memory (EPROM), electrically erasable programmable read-only memory (EEPROM), etc.), and volatile memory 1010 (e.g., random-access memory (RAM)), or any other medium which can be used to carry or store desired program code in the form of machine-executable instructions or data structures and which can be accessed by a computer or other machine with processing circuitry 1002. A basic input/output system (BIOS) 1012 may be stored in the non-volatile memory 1008 and can include the basic routines that help to transfer information between elements within the computer system 1000.

The computer system 1000 may further include or be coupled to a non-transitory computer-readable storage medium such as the storage device 1014, which may comprise, for example, an internal or external hard disk drive (HDD) (e.g., enhanced integrated drive electronics (EIDE) or serial advanced technology attachment (SATA)), HDD (e.g., EIDE or SATA) for storage, flash memory, or the like. The storage device 1014 and other drives associated with computer-readable media and computer-usable media may provide non-volatile storage of data, data structures, computer-executable instructions, and the like.

Computer-code which is hard or soft coded may be provided in the form of one or more modules. The module(s) can be implemented as software and/or hard-coded in circuitry to implement the functionality described herein in whole or in part. The modules may be stored in the storage device 1014 and/or in the volatile memory 1010, which may include an operating system 1016 and/or one or more program modules 1018. All or a portion of the examples disclosed herein may be implemented as a computer program 1020 stored on a transitory or non-transitory computer-usable or computer-readable storage medium (e.g., single medium or multiple media), such as the storage device 1014, which includes complex programming instructions (e.g., complex computer-readable program code) to cause the processing circuitry 1002 to carry out actions described herein. Thus, the computer-readable program code of the computer program 1020 can comprise software instructions for implementing the functionality of the examples described herein when executed by the processing circuitry 1002. In some examples, the storage device 1014 may be a computer program product (e.g., readable storage medium) storing the computer program 1020 thereon, where at least a portion of a computer program 1020 may be loadable (e.g., into a processor) for implementing the functionality of the examples described herein when executed by the processing circuitry 1002. The processing circuitry 1002 may serve as a controller or control system for the computer system 1000 that is to implement the functionality described herein.

The computer system 1000 may include an input device interface 1022 configured to receive input and selections to be communicated to the computer system 1000 when executing instructions, such as from a keyboard, mouse, touch-sensitive surface, etc. Such input devices may be connected to the processing circuitry 1002 through the input device interface 1022 coupled to the system bus 1006 but can be connected through other interfaces, such as a parallel port, an Institute of Electrical and Electronic Engineers (IEEE) 1394 serial port, a Universal Serial Bus (USB) port, an IR interface, and the like. The computer system 1000 may include an output device interface 1024 configured to forward output, such as to a display, a video display unit (e.g., a liquid crystal display (LCD) or a cathode ray tube (CRT)). The computer system 1000 may include a communications interface 1026 suitable for communicating with a network as appropriate or desired.

The operational actions described in any of the exemplary aspects herein are described to provide examples and discussion. The actions may be performed by hardware components, may be embodied in machine-executable instructions to cause a processor to perform the actions, or may be performed by a combination of hardware and software. Although a specific order of method actions may be shown or described, the order of the actions may differ. In addition, two or more actions may be performed concurrently or with partial concurrence.

The terminology used herein is for the purpose of describing particular aspects only and is not intended to be limiting of the disclosure. As used herein, the singular forms “a,” “an,” and “the” are intended to include the plural forms as well, unless the context clearly indicates otherwise. As used herein, the term “and/or” includes any and all combinations of one or more of the associated listed items. It will be further understood that the terms “comprises,” “comprising,” “includes,” and/or “including” when used herein specify the presence of stated features, integers, actions, steps, operations, elements, and/or components, but do not preclude the presence or addition of one or more other features, integers, actions, steps, operations, elements, components, and/or groups thereof.

It will be understood that, although the terms first, second, etc., may be used herein to describe various elements, these elements should not be limited by these terms. These terms are only used to distinguish one element from another. For example, a first element could be termed a second element, and, similarly, a second element could be termed a first element without departing from the scope of the present disclosure.

Relative terms such as “below” or “above” or “upper” or “lower” or “horizontal” or “vertical” may be used herein to describe a relationship of one element to another element as illustrated in the Figures. It will be understood that these terms and those discussed above are intended to encompass different orientations of the device in addition to the orientation depicted in the Figures. It will be understood that when an element is referred to as being “connected” or “coupled” to another element, it can be directly connected or coupled to the other element, or intervening elements may be present. In contrast, when an element is referred to as being “directly connected” or “directly coupled” to another element, there are no intervening elements present.

Unless otherwise defined, all terms (including technical and scientific terms) used herein have the same meaning as commonly understood by one of ordinary skill in the art to which this disclosure belongs. It will be further understood that terms used herein should be interpreted as having a meaning consistent with their meaning in the context of this specification and the relevant art and will not be interpreted in an idealized or overly formal sense unless expressly so defined herein.

It is to be understood that the present disclosure is not limited to the aspects described above and illustrated in the drawings; rather, the skilled person will recognize that many changes and modifications may be made within the scope of the present disclosure and appended claims. In the drawings and specification, there have been disclosed aspects for purposes of illustration only and not for purposes of limitation, the scope of the disclosure being set forth in the following claims.

What is claimed is:

1. A computer system comprising processing circuitry configured to:
receive a braking request for braking a vehicle including an electrically powered tractor with an electric machine coupled to a rear drive axle of the tractor, and a trailer coupled to the tractor by an articulated coupling;
provide a first braking command encoding instructions to control braking on at least a front axle of the tractor, and on the rear drive axle of the tractor to provide a combined braking force fulfilling the braking request;
receive a first set of vehicle parameters;
determine, based on the first set of vehicle parameters, that an understeer tendency of the vehicle during braking is higher than a predefined first understeer tendency threshold; and
provide a second braking command encoding instructions to increase a braking force on the rear drive axle of the tractor using regeneration, and decrease a braking force on the front axle of the tractor, so that the combined braking force fulfills the braking request.

2. The computer system of claim 1, wherein:
the first braking command additionally encodes instructions to control braking on at least one axle of the trailer; and
the second braking command additionally encodes instructions to decrease a braking force on the at least one axle of the trailer.

3. The computer system of claim 1, wherein the processing circuitry is further configured to:
receive a second set of vehicle parameters after having provided the second braking command;
determine, based on the second set of vehicle parameters, that the understeer tendency of the vehicle during braking is lower than a predefined second understeer tendency threshold, lower than the first understeer tendency threshold; and
provide a third braking command encoding instructions to decrease the braking force on the rear drive axle of the tractor, and increase the braking force on the front axle of the tractor, so that the combined braking force fulfills the braking request.

4. The computer system of claim 1, wherein the processing circuitry is further configured to:
receive a third set of vehicle parameters after having provided the second braking command;
determine, based on the third set of vehicle parameters that that an oversteer tendency of the vehicle during braking is higher than a predefined oversteer tendency threshold; and
provide a fourth braking command encoding instructions to reduce the braking force on the rear drive axle of the tractor.

5. The computer system of claim 4, wherein the fourth braking command further encodes instructions to increase the braking force on the front axle of the tractor, so that the combined braking force fulfills the braking request.

6. The computer system of claim 5, wherein the fourth braking command further encodes instructions to increase the braking force on the at least one axle of the trailer.

7. The computer system of claim 1, wherein the processing circuitry is further configured to:
receive a propulsion request for propelling a vehicle including an electrically powered tractor with a first electric machine coupled to a rear drive axle of the tractor, a second electric machine coupled to a front drive axle of the tractor, and a trailer coupled to the tractor by an articulated coupling;
provide a first propulsion command encoding instructions to control the first electric machine and the second electric machine to provide a combined propulsion force fulfilling the propulsion request;
receive a fourth set of vehicle parameters after having provided the first propulsion command;
determine, based on the fourth set of vehicle parameters, that an understeer tendency of the vehicle during propulsion is higher than a predefined third understeer tendency threshold; and
provide a second propulsion command encoding instructions to control the first electric machine and the second electric machine to increase a propulsion force on the rear drive axle of the tractor, and decrease a propulsion force on the front axle of the tractor, so that the combined propulsion force fulfills the propulsion request.

8. A vehicle comprising the computer system of claim 1.

9. The vehicle of claim 8, wherein the vehicle includes an electrically powered tractor with an electric machine coupled to a rear drive axle of the tractor.

10. The vehicle of claim 8, wherein the vehicle includes an electrically powered tractor with a first electric machine coupled to a rear drive axle of the tractor, a second electric machine coupled to a front drive axle of the tractor.

11. A computer-implemented method of reducing understeer of a vehicle including an electrically powered tractor with an electric machine coupled to a rear drive axle of the tractor, and a trailer coupled to the tractor by an articulated coupling, the method comprising:
receiving, by a computer system, a braking request for braking the vehicle;
providing, by the computer system, a first braking command encoding instructions to control braking on at least a front axle of the tractor, and on the rear drive axle of the tractor to provide a combined braking force fulfilling the braking request;
receiving, by the computer system, a first set of vehicle parameters;
determining, by the computer system, based on the first set of vehicle parameters, that an understeer tendency of the vehicle during braking is higher than a predefined first understeer tendency threshold; and
providing, by the computer system, a second braking command encoding instructions to increase a braking force on the rear drive axle of the tractor using regeneration, and decrease a braking force on the front axle of the tractor, so that the combined braking force fulfills the braking request.

12. The method of claim 11, wherein:
the first braking command additionally encodes instructions to control braking on at least one axle of the trailer; and
the second braking command additionally encodes instructions to decrease a braking force on the at least one axle of the trailer.

13. The method of claim 11, wherein the method further comprises:
receiving, by the computer system, a second set of vehicle parameters after having provided the second braking command;
determining, by the computer system, based on the second set of vehicle parameters, that the understeer tendency of the vehicle during braking is lower than a predefined second understeer tendency threshold, lower than the first understeer tendency threshold; and
providing, by the computer system, a third braking command encoding instructions to decrease the braking force on the rear drive axle of the tractor, and increase the braking force on the front axle of the tractor, so that the combined braking force fulfills the braking request.

14. A computer program product comprising program code for performing, when executed by the processing circuitry, the method of claim 11.

15. A non-transitory computer-readable storage medium comprising instructions, which when executed by the processing circuitry, cause the processing circuitry to perform the method of claim 11.
